(19) United States
(12) Patent Application Publication
(10) Pub. No.: US 2026/0318208 A1
(43) Pub. Date: Oct. 15, 2026

(54) ACTIVE FLOW CONTROL ENABLED VARIABLE AREA TURBINE VANE

(71) Applicant: Ohio State Innovation Foundation, Columbus, OH (US)

(72) Inventors: Alexander SPENS, Everett, MA (US); Jeffrey BONS, Dublin, OH (US)

(21) Appl. No.: 19/484,758

(22) PCT Filed: May 16, 2024
(86) PCT No.: PCT/US2024/029680

§ 371 Date: Nov. 14, 2025

Related U.S. Application Data
(60) Provisional application No. 63/466,837, filed on May 16, 2023.

(51) Int. Cl. F01D 17/16

(52) U.S. Cl. CPC F01D 17/16; F05D 2240/12

(57) ABSTRACT

A system may include a first blade and a second blade, each comprising an upper surface, a lower surface, a leading edge, and a trailing edge. The first blade and the second blade are spaced apart to define a throat area through which a fluid can flow. The device may include a first active flow control port disposed on the upper surface of the first blade and a second active flow control port disposed on the upper surface of the first blade closer to the trailing edge than the first active flow control port. The first and second active flow control ports are configured to inject a control fluid into the throat area to vary at least one of (i) a cross-sectional area of the fluid flowing through the throat area and (ii) an exit angle of the fluid leaving the throat area adjacent to the trailing edge.

### CROSS-REFERENCE TO RELATED APPLICATIONS

This application claims priority to U.S. Provisional Patent Application No. 63/466,837 filed May 16, 2023, which is incorporated herein by reference in its entirety.

### BACKGROUND

The ability to alter the amount of mass flow through the turbine of a gas turbine engine provides the capability to improve the cycle efficiency over a range of operating conditions. The control of the turbine mass flow provides a means to decouple the core flow of an engine from its rotational velocity, allowing for increased pressure ratios and higher thermal efficiencies at lower power settings. This also provides an increase in responsiveness as there is less delay waiting for high-inertia rotating parts to match the commanded throttle setting. These capabilities would prove advantageous in improving the efficiency and capabilities of military and commercial aircraft. As well as other gas turbine applications such as those with a free turbine system (some turbo-prop aircraft, helicopters, marine engines, and power generators) where alterations of power settings mean that the optimal run point conditions are not always present.

One method of altering the flow through the turbine is through the use of variable nozzle guide vanes, which are located at the entrance to the turbine. These vanes can alter their throat area, which in turn alters the amount of flow that can pass. One of the proposed methods of creating these variable vanes is by physically rotating them through the use of an attached trunnion which extends through the turbine case. However, this creates a myriad of engineering challenges due to the high pressures and temperatures in the turbine, which require secondary cooling flows for durability.

Therefore, a need exists for improved nozzle guide vanes and flow control systems.

### SUMMARY

One implementation of the present disclosure is a system including a first blade, a second blade, a first active flow control port, and a second active flow control port. The first blade and the second blade each include an upper surface (e.g., suction surface), a lower surface (e.g., pressure surface) spaced apart from the upper surface, a leading edge, and a trailing edge. The first blade and the second blade are spaced apart to define a throat area through which a fluid can flow in a direction from the leading edge to the trailing edge. The first active flow control port is disposed on the upper surface of the first blade. The second active flow control port is disposed on the upper surface of the first blade closer to the trailing edge than the first active flow control port. Each of the first and second active flow control ports is configured to inject a control fluid into the throat area to vary at least one of (i) a cross-sectional area of the fluid flowing through the throat area (e.g., vary the throat area of the nozzle guide vane, or the throat area between adjacent blades of the rotor blade) and (ii) an exit angle of the fluid as it leaves the throat area adjacent to the trailing edge.

In some implementations, the first active flow control port is a blockage port configured to inject the control fluid into the throat area to reduce the cross-sectional area of the fluid flowing through the throat area (e.g., the effective throat area between the first and second blades).

In some implementations, the second active control port is a recovery port placed in close proximity to the blockage port, the recovery port being closer to the trailing edge of the first blade than the blockage port, wherein each of the blockage port and the recovery port is configured to inject the control fluid into the throat area to vary the cross-sectional area of the fluid flowing through the throat area.

In some implementations, the control fluid from the blockage port separates the fluid from the first blade.

In some implementations, the control fluid from the recovery port attaches the fluid back to the first blade.

In some implementations, the upper surface of the first blade is a suction surface of the first blade, the lower surface of the second blade is a pressure surface, and the throat area is defined by the pressure surface of the second blade and the suction surface of the first blade.

In some implementations, the system is a turbine system and the first blade and the second blade are turbine blades.

In some implementations, the second active flow control port is a vortex-generating jet.

In some implementations, the control fluid exiting the second active flow control port oscillates with a first frequency in a plane substantially parallel to the upper surface of the first blade.

In some implementations, the system further includes a third active flow control port disposed on the lower surface of the second blade opposite the first and second active flow control ports.

In some implementations, the exit angle of the fluid as it leaves the throat area is altered by greater than 1 degree when the control fluid is dispensed from the third active flow control port.

In some implementations, the system further includes a control fluid source in fluid communication with the first and second active flow control ports.

In some implementations, the first active flow control port is a plurality of first active flow control ports arranged on the upper surface of the first blade in a transverse direction along a width of the first blade that is perpendicular to the direction of the fluid flowing through the throat area.

In some implementations, the second active flow control port is a plurality of second active flow control ports arranged on the upper surface of the first blade in the transverse direction.

In some implementations, the second active flow control port is placed on the upper surface of the first blade directly opposite the trailing edge of the second blade.

In some implementations, a blocked flow fraction of the first and second active flow control ports is greater than 10%.

Another implementation of the present disclosure is a system including: a plurality of turbine blades arranged adjacent to each other in a device, the plurality of turbine blades including a first blade and a second blade each including an upper surface (e.g., suction surface), a lower surface (e.g., pressure surface) spaced apart from the upper surface, a leading edge, and a trailing edge, wherein the first blade and the second blade are spaced apart to define a throat area through which a fluid can flow in a direction from the leading edge to the trailing edge; a first active flow control port disposed on the upper surface of the first blade; a first injector plenum partially defined by the first blade and in fluid communication with the first active flow control port; a second active flow control port disposed on the upper surface of the first blade closer to the trailing edge than the first active flow control port; and a second injector plenum partially defined by the first blade and in fluid communication with the second active flow control port, the second injector plenum being separate from the first injector plenum, wherein each of the first and second active flow control ports are configured to inject a control fluid into the throat area to vary at least one of (i) a cross sectional area of the fluid flowing through the throat area (e.g., vary the nozzle guide vane throat area) and (ii) an exit angle of the fluid as it leaves the throat area adjacent to the trailing edge.

In some implementations, the first active flow control port is a plurality of first active flow control ports arranged on the upper surface of the first blade in a transverse direction along a width of the first blade that is perpendicular to the direction of the fluid flowing through the throat area.

In some implementations, the system further includes a fluid source in fluid communication with one or more of the first injector plenum and the second injector plenum.

Another implementation of the present disclosure is a method of altering the flow conditions through a turbine system, the method including: providing a turbine (e.g., a high pressure turbine) including: at least one turbine blade including a first blade and a second blade, each of the at least one turbine blades having an upper surface (e.g., suction surface), a lower surface (e.g., pressure surface) spaced apart from the lower surface, a leading edge, and a trailing edge, wherein the first blade and the second blade are spaced apart to define a throat area through which a fluid can flow in a direction from the leading edge to the trailing edge; a first active flow control port disposed on the upper surface of the first blade; and a second active flow control port disposed on the upper surface of the first blade closer to the trailing edge than the first active flow control port, injecting a control fluid into the throat area via the first active flow control port to disconnect the fluid flowing through the throat area from the upper surface of the first blade, thus reducing an effective throat area; and injecting a control fluid into the throat area via the second active flow control port to reattach the fluid flowing through the throat area to the upper surface of the first blade, wherein the control fluid injected via the second active flow control port oscillates with a first frequency in a direction transverse to the fluid flow direction, wherein the reduced flow conditions in the throat area produce an increased efficiency of the turbine system.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1 is a simplified engine diagram, according to one implementation.

FIG. 2 shows a diagram of a system with a variable vane and the associated geometric measurements and changes, according to one implementation.

FIG. 3 shows a section of a turbine showing trunnions that connect through the compressor case to the variable vanes, according to one implementation.

FIG. 4 shows a cross-section of a variable geometry blade system, according to one implementation.

FIG. 5 shows a cross-section of a variable geometry blade system, according to another implementation.

FIG. 6 shows a cross-section diagram displaying various scenarios and implementations of the fluidic active flow control ports of the present disclosure.

FIG. 7 shows a cross-sectional diagram of a blade system including fluidic active control ports, according to one implementation.

FIG. 8 shows a cross-sectional diagram of a blade system including fluidic active control ports, according to another implementation.

FIG. 9 shows a cross-sectional diagram of a blade system including fluidic active control ports, according to another implementation.

FIG. 10 and FIG. 11 show a three-dimensional diagram of a blade system having active flow control ports with various views, according to one implementation.

FIG. 12 shows a schematic of an experimental testing rig design along with a converging-diverging nozzle test section, according to one implementation.

FIG. 13 shows an experimental nozzle guide vane test section including a tailboard, according to one implementation.

FIG. 14 shows a cross-section of the experimental test section of FIGS. 12 and 13, along with a detailed view, according to one implementation.

FIG. 15 shows a full diagram with multiple views of a nozzle guide vane testing rig, according to one implementation.

FIG. 16 shows a graph comparing the Mach number profile between computational and experimental analyses, according to one implementation.

FIG. 17 shows a graph of various amounts of active flow control flow between 50 3000 standard liters per minute (SLPM) and 300 SLPM injected through the upstream slot of an experimental testing rig and the resulting mass flow throttling effectiveness (ηₘ), according to one implementation.

FIG. 18 shows shadowgraph images of baseline, 200 SLPM, and 300 SLPM of injected flow, according to one implementation.

FIG. 19 shows a graph of the resulting aerodynamic throat, estimated from the shadowgraph images of FIG. 18, according to one implementation.

FIG. 20 shows a graph of active flow control throttling effectiveness for various AFC actuators implemented on nozzle guide vane (NGV) designs, according to one implementation.

FIG. 21 shows a graph plotting the effectiveness of the converging-diverging nozzle (CDN) slot injection over a variety of nozzle pressure ratios (NPRs), according to one implementation.

FIG. 22 plots the effectiveness of each of the NGV AFC configurations at an active flow control pressure ratio (PR_{AFC}) of 1.0 over a range of exit Mach numbers, according to one implementation.

FIG. 23 shows shadowgraph images with shocks in the baseline flow near the throat, according to various implementations.

FIG. 24 shows a graph plotting the various pressure recovery profiles, according to one implementation.

FIG. 25 plots the area average total pressure recovery (γₐ) calculated for each of the AFC actuators, according to one implementation.

FIG. 26 plots the variation in blocked flow for each of the actuators over the tested PR_{AFC} range (0.8-1.1), according to one implementation.

FIG. 27 plots a summary of the injected flow and blocked flow for various testing scenarios.

FIG. 28 plots the change in total pressure recovery as a function of the blocked flow, according to various implementations.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

### Contextual Examples and Description

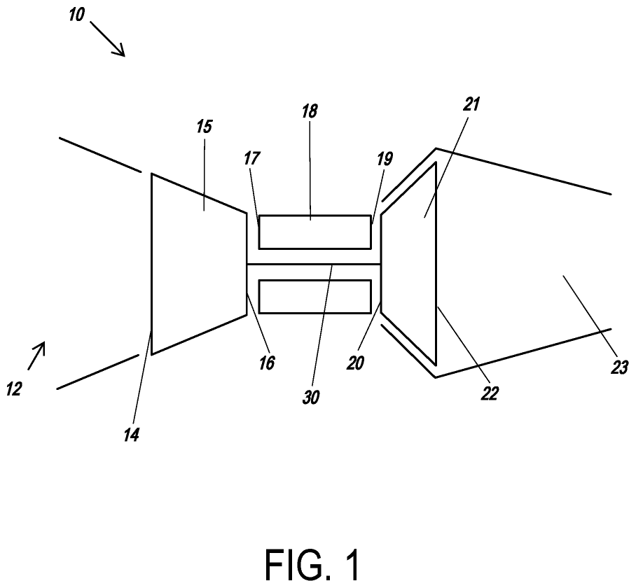

FIG. 1 is a simplified engine diagram providing a basis for discussion of the various elements of this disclosure. The engine 10 shown in FIG. 1 includes an engine inlet 12 configured to intake air from the surrounding environment. A compressor 15 has a compressor inlet 14 and a compressor outlet 16 is placed adjacent to the engine inlet 12. The compressor 15 takes air from the engine inlet 12 and generally compresses the air to increase the pressure of the air in the engine 10. The compressor 15 may include a plurality of compressor stages that increase the pressure of the air incrementally.

A combustor 18 is placed adjacent to the compressor 15, the combustor 18 defined by a combustor inlet 17 and a combustor outlet 19. The combustor 18 takes the highly compressed air from the compressor 15 and mixes in fuel to create an air-fuel mixture. The combustor 18 then ignites the mixture to create a high-energy gas stream. This gas stream expands rapidly, driving turbine blades within a turbine 21 downstream and ultimately providing a thrust.

A turbine 21 is placed adjacent to the combustor outlet 19 of the combustor 18 defined by a turbine inlet 20 and a turbine outlet 22. The high-pressure, high-temperature gases generated in the combustion chamber flow into the turbine 21 of the engine. These gases expand rapidly and exert force on the turbine blades in the turbine 21. The turbine 21 may be connected to a shaft 30 that drives the compressor 15 of the engine or some other application as well. As the turbine blades rotate, they transfer mechanical energy to the compressor shaft 30. After passing through the turbine 21, the gases are then expelled from the engine through the exhaust nozzle 23 at high velocity, generating thrust.

In some implementations of jet engines or other similar engines, variable high-pressure turbines may be used. A variable high-pressure turbine (HPT) provides one method of increasing the off-design efficiency of gas turbine engines. A variable turbine functions by altering the throat area and exit angle of the nozzle guide vanes (NGVs), which are located at the turbine inlet. This changes the maximum mass flow rate allowed through the engine core, as well as the swirl angle of the flow relative to the turbine rotor blades. Typically, an engine is designed and optimized for a certain set of conditions (i.e. flow coefficient or axial velocity and rotational frequency). For example, this could represent optimal performance at full military thrust and/or at standard sea-level conditions. However, due to the nature of gas turbines, running at conditions outside of what was optimized for typically incurs a large efficiency penalty. The ability to vary the mass flow rate and exit swirl angle allows the engine to perform at high efficiency during off-design conditions.

In an engine with a fixed high-pressure turbine (HPT) flow path, the output thrust can be controlled by varying the fuel flow to the combustor. This in turn alters the turbine inlet temperature, extracted turbine power, and compression ratio. In a variable throat HPT, the mass flow rate through the core is set along with the fuel flow rate. In conjunction with other variable geometry components, this can shift flow away from the core, altering the bypass ratio. For increased range and loiter capability, the bypass ratio can be increased, decreasing the specific fuel consumption. For situations where more thrust is required, the bypass ratio can be decreased, trading fuel efficiency for specific thrust.

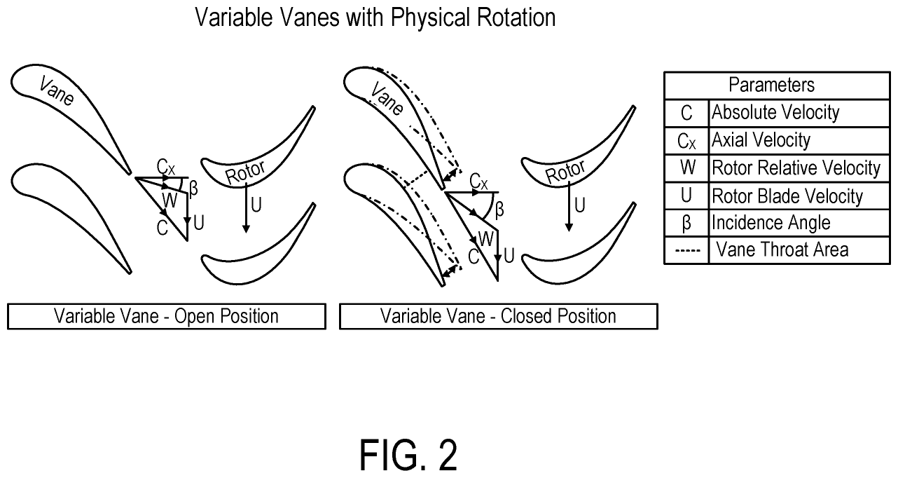

Another useful feature of a variable area turbine is the ability to change the flow swirl angle exiting the nozzle guide vanes. This impacts the angle of the flow relative to the first-stage turbine rotor blades or the blade incidence angle. FIG. 2 depicts how incidence angle and throat area are affected by a variable NGV. For a given rotor blade shape, there is an optimal design incidence angle. Off-design conditions such as varying mass flow rate or rotor speed can change the incidence angle, resulting in efficiency losses for the turbine. With a variable HPT, the incidence angle can be matched to the flow rate and rotor speed to ensure maximum efficiency over a range of off-design conditions.

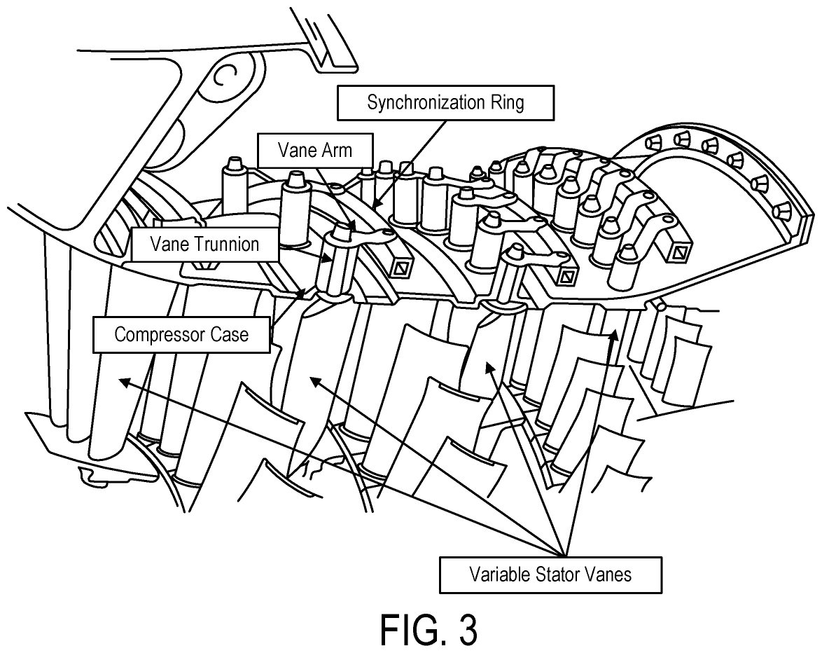

Variable vanes are already used in the compressors of some modern day commercial and military engines. Compressors use variable stators to increase stability at low flow rates, and function by restricting airflow and altering flow angle. At low flow rates, variable stators can restrict airflow to the higher stages of the compressor, preventing choking. In the closed position, the stators also allow for a higher swirl angle of the flow, to prevent separation and stall over the compressor blades. Typically, the vanes are actuated using a synchronization ring driven by hydraulic actuators. This rotates trunnions which connect through the compressor case to the variable vanes, as shown in FIG. 3.

There are many design challenges involved with this system. These include reducing the gaps between the stator and flow path wall and keeping the seal around the trunnion tight enough to prevent leakages but loose enough to prevent binding. Additional focus is also required for the attachment between the trunnion and the vane, as this is an area prone to high stresses. All of these factors would be compounded if mechanically driven variable stators were implemented in the hot environment of an HPT with its large thermal growths, high pressures, and internal cooling flows. For example, some studies have experienced these challenges during proof-of-concept rig tests with various rotating turbine vane concepts. Similar to blade tip leakages for rotors, vane tip leakages may be a significant source of efficiency loss.

### Proposed Active Flow Control and Examples

One possible alternative to realize the benefits of variable vane turbines, without having to confront the challenges associated with mechanical actuation, is through the use of Active Flow Control (AFC). Active Flow Control may be used in a variety of applications, for example, for high lift devices, separation delay, and aerodynamic drag reduction. Some implementations of common AFC actuators include (but are not limited to): plasma actuators, shape memory alloys, fluidic actuators, micro-combustors, etc. Fluidic AFC actuators manipulate the flow through the use of steady, pulsing, or sweeping jets. Recently developed additive manufacturing technologies, such as Direct Metal Laser Sintering (DMLS), allow for more complex and efficient fluidic actuator designs to be embedded in aerodynamic surfaces-even in the high-temperature alloys, such as Inconel 718, used for turbine vane fabrication. Because AFC works while the vanes are fixed, the challenges associated with rotating variable vanes can be avoided. However, in other implementations, fluidic AFC ports may be used with the rotor stage of the engine. Additionally, the technology required to supply fluidic AFC actuators with high-pressure air is similar to existing turbine engine architectures used for cooling flows. The flow used to cool the HPT is sourced from the high-pressure compressor. This results in a small efficiency loss, however typically only 10 to 15% of the flow through the engine core is used for cooling.

Previous studies of throat area modulation using fluidic actuators include research on throat area control for convergent divergent nozzles. In some implementations of throat area modulation using fluidic actuators, including for throat area control for convergent divergent nozzles, the primary mass flow is reduced by approximately twice the mass flow injected by the actuators. In some systems, the amount of modulation for a variable NGV throat is between a 20-40% reduction of the primary flow. In some implementations, it is estimated that 10-20% of the core airflow would be needed to create an active flow control (AFC) modulated nozzle guide vane (NGV) variable throat, which is comparable to the amount of flow used for cooling the high-pressure turbine (HPT).

Fluidic actuators are also used to change the exit angle of the flow from a high-speed nozzle. For example, by applying asymmetrical flow injection to a Mach 1.56 nozzle, the thrust may be vectored by up to 17 degrees. Other AFC devices like fluidic Gurney flaps have been shown to substantially alter the effective camber and flow angle of air flowing over a wing. In some implementations, a 5% increase in turbine stage efficiency can be obtained from a 10-degree variation in rotor incidence angle. In addition, other flow control methods (such as fluidic oscillators and pulsing jets) may effectively control flow separation in the low-pressure turbine and over wings, and have potential for use in the high-pressure turbine.

In some implementations, steady slot jets are used on an NGV cascade to alter the throat area. The injection locations may be altered and/or optimized based on maximizing the primary flow blockage relative to the injected mass, momentum, and energy fluxes. In some implementations, the suction side throat region may be a more efficient injection location (e.g., blocking 36% of the primary flow); however, the suction side implementations may result in undesirably high stagnation losses due to the separated flow and large wake created downstream. Alternatively, injecting flow from the pressure side may be less efficient at reducing the throat area, but may result in much lower stagnation pressure losses. In some implementations of an AFC-actuated variable area turbine design, the stagnation pressure losses are kept low and strategically combine exit flow vectoring with throat area reduction to minimize the required high-pressure injection mass flow.

### Example Systems and Devices

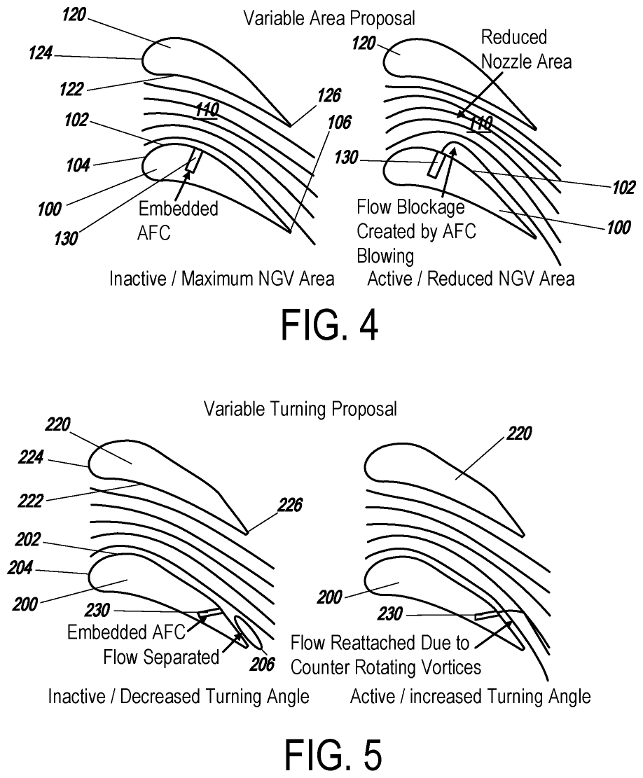

FIG. 4 and FIG. 5 show two disclosed designs for creating a variable geometry blade system (e.g., a turbine, a compressor, or any other multi-bladed system). Throughout this disclosure, blade systems are shown which, in some implementations, may be blades of a turbine (e.g., individual blades of a stator vane or a rotor blade). While individual examples may refer to one or another (e.g., a nozzle guide vane), it is understood that the active flow control implementations of this disclosure are not limited to any individual blade system.

The diagrams of FIGS. 4 and 5 are two-dimensional cross-sections of a blade system (e.g., turbine blades), and it is understood that a three-dimensional implementation may include a curvature to the blade surfaces. FIG. 4 shows a first blade 100 adjacent to and spaced apart from a second blade 120. The first blade 100 includes a leading edge 104 and a trailing edge 106. The second blade 120 similarly includes a leading edge 124 and a trailing edge 126. An upper surface 102 of the first blade 100 is arranged opposite from a lower surface 122 of the second blade 120 to define a throat area 110 (e.g., a nozzle guide vane area, or a flow area) therebetween.

The first blade 100 includes an embedded fluidic active control port 130 (labeled “embedded AFC”). The left panel of FIG. 4 shows the maximum throat area 110 wherein the embedded AFC 130 is inactive. The right panel of FIG. 4 shows the active embedded AFC 130 injecting a fluid (e.g., air) into the throat area 110. The throat area 110 is reduced by the created blockage from the steady jet of fluid from the embedded fluidic active control port 130. In some implementations, the effective nozzle area is reduced by up to 70%.

FIG. 5 shows a blade system (e.g., an individual blade structure of either a stator vane or rotor blade of a turbine) comprising a first blade 200 and a second blade 220, similar in structure and function to the blades 100, 120 of FIG. 4. The first blade 200 includes an upper surface 202, a leading edge 204, and a trailing edge 206. The second blade 220 includes a lower surface 222, a leading edge 224, and a trailing edge 226. A throat area 210 is defined between the upper surface 202 of the first blade 200 and the lower surface 222 of the second blade 220.

The first blade 200 includes an embedded fluidic active control port 230 (labeled “embedded AFC”) defined on the upper surface 202. The embedded AFC 230 of FIG. 5 is closer to the trailing edge 206 of the first blade 100 as compared to the FIG. 4 design. The left panel of FIG. 5 shows that the flow of fluid through the throat area 210 adjacent to the first blade 200 separates from the trailing edge 206 under normal operating conditions. The right panel of FIG. 5 shows the embedded AFC 230 injecting a steady jet of fluid, which alters the flow exit angle by reattaching the flow to the trailing edge 206 with a steeper exit angle. The difference between the separated and attached flow using the embedded AFC 230 may be up to 25 degrees. The embedded AFC port 230 may dispense an oscillatory or sweeping jet of fluid (e.g., via an embedded fluidic oscillator structure).

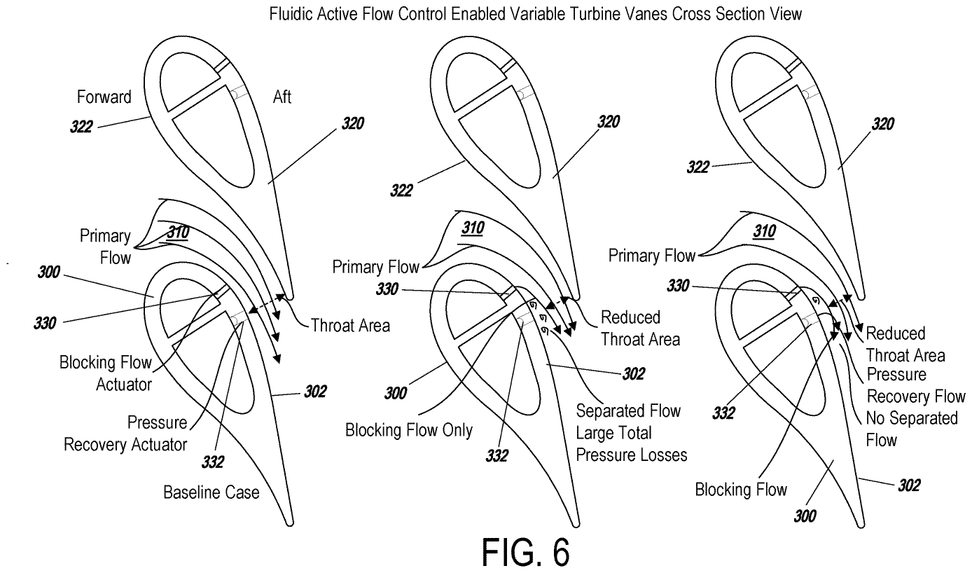

FIG. 6 shows a similar diagram as FIGS. 4 and 5, displaying various scenarios and implementations of the fluidic active flow control ports of the present disclosure. For example, the left panel shows two blades—an upper blade 320 and a lower blade 300 adjacent to each other (e.g., in either the stator vane stage or the rotor blade stage of a turbine). The primary flow of fluid through the throat area 310 defined by a lower surface 322 of the upper blade 320 and an upper surface 302 of the lower blade 300 is unaltered in the baseline case. As shown, the upper surface 302 of the lower blade 300 (e.g., the suction surface of the lower blade) includes two active flow control ports—a blocking flow actuator 330 and a pressure recovery actuator 332. Each of the AFC ports 330, 332 are defined by the suction surface or upper surface 302 of the lower blade 300 (e.g., by a circular opening) and are in fluid communication with a control fluid source (e.g., a compressor with a conduit coupled to the AFC port).

In the middle panel of FIG. 6, the blocking flow actuator AFC port 330 has been activated to dispense a flow of the control fluid into the flow path. The steady-state flow from the blocking AFC port 330 partially blocks flow through the throat area 310 by reducing the effective throat area of the blade system. A separated flow area is created immediately downstream of the blocking AFC port 330, resulting in large total pressure losses.

In the right panel of FIG. 6, the pressure recovery AFC port 332 has been activated to dispense a flow of the control fluid into the flow path. The flow from the pressure recovery AFC port 332 may be steady or may be an oscillating flow. The flow from the pressure recovery AFC port 332 reattaches the fluid flow to the upper surface 302 (e.g., suction surface) of the lower blade 300 while maintaining the reduced throat area 310 created by the blocking AFC port 330. Thus, while the flow through the two blades is reduced, the flow is not separated at the trailing edge.

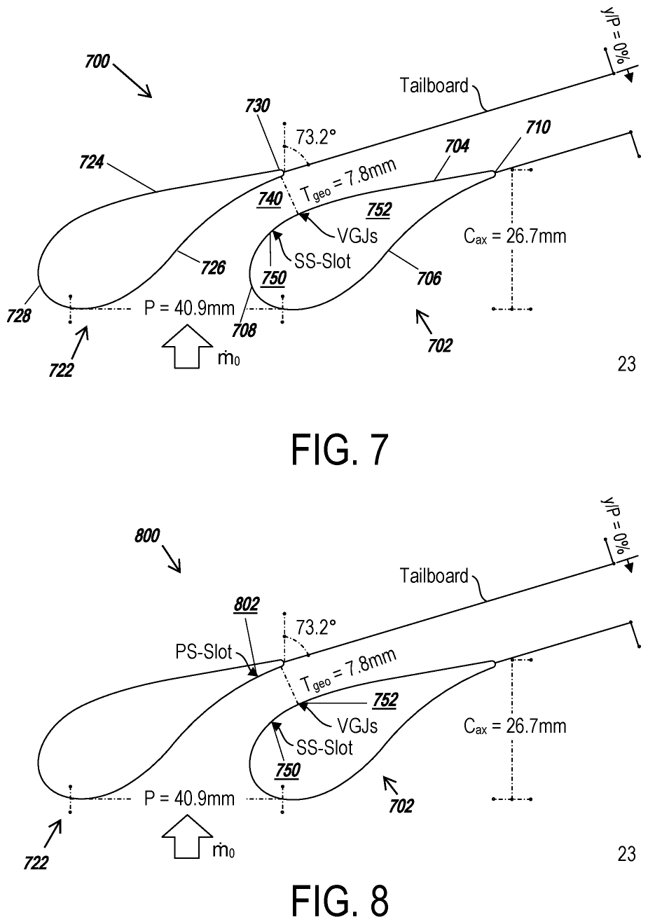

FIG. 7 shows a diagram of a blade system (e.g., turbine blades) having fluidic active control ports, according to another implementation, along with example dimensions. The system 700 of FIG. 7 includes a first blade 702 and a second blade 722. In some examples, the first blade is an upper blade and the second blade is a lower blade, each blade being adjacent to each other in a stator vane of a turbine (e.g., forming a nozzle guide vane). In other implementations, the first and second blades are adjacent to each other in a rotor blade stage of a turbine. In other implementations, the first and second blades of the blade system are disposed within a compressor. In general, throughout this disclosure, reference to one or more of a vane and/or rotor of a turbine or other blade system is exemplary only, and it is understood that the various structures and fluid ports of the present disclosure may be implemented into either the vane or rotor of a turbine. The generic term “blade” (or “turbine blade”) is used to describe a single blade structure of a blade system, which may be a vane (e.g., nozzle guide vane) or a rotor of a turbine or any other fluid system including staged blades.

The first blade 702 includes an upper surface 704 (e.g., a suction surface) and a lower surface 706 (e.g., a pressure surface) spaced apart from the upper surface 704. The first blade 702 further includes a leading edge 708 and a trailing edge 710.

The second blade 722 also includes an upper surface 724 (e.g., a suction surface) and a lower surface 726 (e.g., a pressure surface) spaced apart from the upper surface 724. The second blade 722 further includes a leading edge 728 and a trailing edge 730.

The first blade 702 is arranged adjacent to, and spaced apart from, the second blade 722, as shown in FIG. 7. A throat area 740 is defined between the upper surface 704 of the first blade 702 and the lower surface 726 of the second blade 722. In use, a fluid can flow through the throat area 740 in a direction from the leading edge 708 to the trailing edge 710 of the first blade 702.

A first active flow control port 750 (e.g., a blockage port) is defined by and disposed on the upper surface 704 of the first blade 702. A second active flow control port 752 (e.g., a recovery port) is defined by and disposed on the upper surface 704 of the first blade 702. The first active flow control port 750 is adjacent to but spaced apart from, the second active flow control port 752 such that the second active flow control port 752 is further in the downstream direction closer to the trailing edge 710.

The first active flow control port 750 and the second active flow control port 752 are each configured to inject a control fluid into the throat area 740. The injected control fluid varies at least one of (i) a cross-sectional area of the fluid flowing through the throat area 740 (e.g., vary the throat area of a nozzle guide vane, or the throat area between adjacent blades of the rotor blade) and (ii) an exit angle of the fluid as it leaves the throat area 740 adjacent to the trailing edge 710.

The first active flow control port 750 is a blockage port configured to reduce the cross-sectional area of the fluid flowing through the throat area 740. The effective throat area (i.e., the throat area post-control fluid injection when the flow is partially blocked) between the first and second blades 702, 722 is reduced by, for example, separating the fluid from the upper surface 704 of the first blade 702. The first active flow control port 750 injects control fluid in a steady flow; however, in some implementations, the first active flow control port 750 injects control fluid in an oscillating or sweeping pattern.

The second active flow control port 752 is a recovery port placed in close proximity to the blockage port (e.g., the first active flow control port 750). The second active flow control port 752 injects the control fluid to vary the cross-sectional area of the fluid flowing through the throat area 740. The second active flow control port 752 may also simultaneously vary the angle of the fluid exiting the throat area 740 adjacent to the trailing edge 710. The second active flow control port 752 may be a vortex-generating jet wherein the second active flow control port 752 is a fluidic oscillator or similar structure configured to produce an oscillatory or sweeping flow of control fluid. For example, the control fluid may oscillate at a first frequency in a plane that is substantially parallel to the upper surface 704 of the first blade 702. In other implementations, the second active flow control port may inject a steady flow of control fluid.

The first active flow control port 750 and the second active flow control port 752 may be oriented normal to the upper surface 704 of the first blade 702. However, in other implementations, the ports may be oriented at an angle with respect to the upper surface 704 of the first blade 702 (e.g., the second active flow control port 752 may be oriented at a shallow angle with respect to the upper surface 704 to adequately reattach the flow).

In use, the control fluid injected from the first active flow control port 750 and the second active flow control port 752 can vary the total fluid flowing through the throat area 740. A controller coupled to the first active flow control port 750 and the second active flow control port 752 (e.g., with associated valves, conduits, and fluid source(s) coupled to the controller) may be used to vary the flow conditions depending on the application (e.g., take-off stage of an aircraft, high power generation, high-altitude, etc.).

FIG. 8 shows a diagram of a turbine having fluidic active control ports, according to another implementation, along with example dimensions. The system 800 of FIG. 8 is substantially similar to the system 700 of FIG. 7 such that like reference numbers denote like elements, except as described below.

The system 800 further includes a third active flow control port 802 defined by and disposed on the lower surface 726 of the second blade 722. The third active flow control port 802 is arranged on the opposite side of the throat area 740 from the first active flow control port 750 and the second active flow control port 752. The third active flow control port 802 injects a control fluid into the flow path to either reduce the flow area through the throat area 740, adjust the exit angle of the fluid, or both. The third active flow control port 802 operates in conjunction with the first active flow control port 750 and the second active flow control port 752 to produce a desired flow condition for a given operating condition of the system 800.

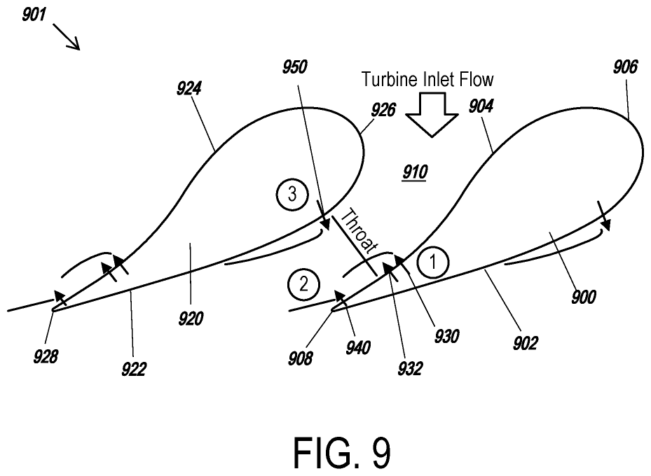

FIG. 9 shows another diagram of a blade system (e.g., a turbine system) with fluidic active flow control ports. The system 901 of FIG. 9 includes a first blade 900 including an upper surface 902, a lower surface 904, a leading edge 906, and a trailing edge 908. The system 901 further includes a second blade 920 includes an upper surface 922, a lower surface 924, a leading edge 926, and a trailing edge 928. A throat area 910 is defined between the upper surface 922 of the second blade 920 and the lower surface 904 of the first blade 900.

FIG. 9 shows three specific concepts, each of which may be implemented (i) independently of the other concepts, (ii) in combination with the other concepts as shown, or (iii) in combination with the other concepts of the present disclosure (e.g., on either a stator vane stage or a rotor blade stage of a turbine). The three initial concepts shown in FIG. 9 include: (1) close-proximity tandem injection for throat area modulation, (2) fluidic Gurney flap on the pressure surface trailing edge for flow turning, and (3) vortex-generator jets or sweeping fluidic oscillator on the suction surface for wake-thinning and flow turning. Again, in other implementations of the present disclosure, the order, arrangement, and surface on which the active control ports are defined may be varied and combined with a variety of other disclosed concepts.

Concept 1 employs a double injection method on the lower surface 904 (e.g., the pressure surface) of the first blade 900 (e.g., a vane pressure surface) near the throat area 910. This concept includes a first port 930 and a second port 932 in close proximity. The first injection of control fluid from the first port 930 creates a blocking flow, which is then used by the second port 932 downstream from the first port 930 to increase the mass, momentum, and energy injection and improve the flow throttling capability.

Concept 2 uses a fluidic Gurney flap 940 to vary the effective camber of the first blade 900 (e.g., the vane) and the exit angle of the flow. In some implementations, the Gurney flap concept can improve circulation and reduce separation bubbles on traditional airfoils. Coupled with Concept 1, the Gurney fluidic actuator 940 of Concept 2 is effective at decreasing the stagnation pressure loss associated with throat area reduction.

Concept 3 utilizes steady, pulsed, or sweeping jet actuators 950 on the upper surface 922 (e.g., the suction surface) of the second blade 920 (e.g., the suction surface of the vane) to preserve attached flow beyond the passage throat. In some implementations, the port 950 of concept 3 injects a control fluid in a streamwise vortex-generating AFC device to keep flow attached over curved surfaces. In addition, the vortex generators may be used ahead of a shock to reduce separation over curved surfaces after the shock.

Each of these designs may be combined together in various configurations to maximize variations in the throat area and exit flow angle while minimizing stagnation pressure loss and required flow. Furthermore, by using fluidic AFC devices such as steady, pulsing, and sweeping jets, the effective throat area and flow turning can be varied continuously over the desired range by adjusting the relative mass flow rates of the actuators.

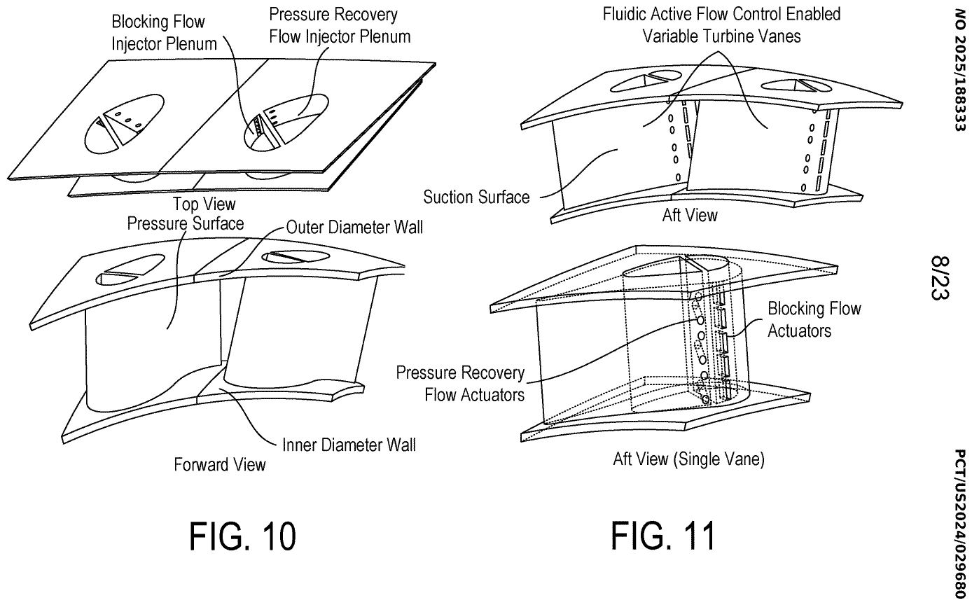

FIG. 10 and FIG. 11 show a three-dimensional view of the turbine, blades, and active flow control ports shown and described in FIGS. 7-9. For example, FIG. 10 shows a top and forward view of a turbine having a first blade and a second blade (e.g., blades of a nozzle guide vane or blades of a rotor blade stage of a turbine). As shown, each of the active flow control ports of FIGS. 7-9 (e.g., the first active flow control port 750 of the first blade 702 in FIG. 7), may be a plurality of active flow control ports (e.g., several holes in the upper surface 704 aligned in a direction perpendicular to the fluid flow direction and parallel to the width of the blade).

As shown, inner and outer diameter walls are included on either end of the blade or blade system. Each set of active flow control ports (e.g., the plurality of first active flow control ports 750) is in fluid communication with an injector plenum defined by the blade surfaces and the perimeter walls. The injector plenum(s) are coupled to a fluid source (e.g., compressor) to provide the control fluid to the active flow control ports.

As shown in FIG. 11, the ports may have a variety of shapes for the opening defined in the surface of the blade. For example, the blocking flow actuators (e.g., first active flow control port 750) is shown as a rectangular opening in the suction surface, and the pressure recovery flow actuators (e.g., second active flow control port 752) is shown as a circular opening in the suction surface. However, in other implementations, either set of active flow control ports may have a variety of outlet shapes (e.g., both circular, both rectangular, elliptical, square, triangular, or an irregular shape, or a combination thereof). Each set of ports is arranged in a linear pattern transverse to the primary flow direction through the throat area. However, in other implementations, the ports are arranged in an offset pattern or any other patterned arrangement.

### Experimental Setup and Results

### Example #1—Active Fluidic Control of a Nozzle Guide Vane Throat

Experiments were conducted to validate the building blocks of a fluidically controlled variable area turbine concept that uses injected high-pressure air to effectively reduce the choke area of the turbine inlet. Preliminary results from a simple quasi-1D converging-diverging nozzle, with an injection flow slot upstream of the throat, showed a 2.2:1 ratio between throttled mass flowrate and injected mass flowrate at a constant nozzle pressure ratio. The penetration of the injection flow and corresponding reduction in the primary flow stream tube was successfully visualized using a shadowgraph technique. Building on this success, a representative single passage nozzle guide vane transonic flow path was constructed to demonstrate feasibility beyond the quasi-1D converging-diverging nozzle. Both secondary slots blowing from the vane pressure surface and vane suction surface just upstream of the passage throat again successfully reduced primary flow. In addition, fluidic vortex generators were used on the adjacent suction surface to reduce total pressure loss and further throttle the primary flow. Implications for the application of this active flow control technology to a variable area turbine are considered.

Existing variable area turbines (VATs) include physically rotated nozzle guide vanes (NGVs) to alter the turbine inlet area and exit swirl of the flow. One alternative to physically rotating the turbine vanes is the use of fluidic active flow control (AFC) to alter the aerodynamic throat and effective camber of a static vane. This method avoids the most challenging complexities associated with physically rotating parts, such as gaps, thermal growths, and cooling flow routing, but also presents new challenges such as effectively and efficiently using the compressor bleed air to alter the flow through the NGVs. Fluidic active flow control technologies may be used in injected slot flow to alter the throat area or thrust direction of a variable exhaust nozzle. Similarly, vortex-generating jets (VGJs) may be used for their abilities to promote mixing and prevent or reattach separated flow.

The objective of this study was to explore the effects of various fluidic active flow control methods for use in a fluidic variable NGV system. Three AFC actuator designs were tested in a subscale transonic nozzle. The reduction in primary flow and total pressure loss were measured over a variety of primary flow Mach numbers and injection flow pressure ratios. Shadowgraph visualization and static pressure taps were used to identify possible causes for differences in performance between each actuator design. Finally, the resulting capabilities and efficiencies of each design presented are discussed.

### Experimental Setup

To quickly explore a range of AFC methods, a rig was developed to handle interchangeable test sections. The test sections were designed to explore various AFC actuators and were additively manufactured to allow for more complex internal flow paths. A set of test procedures was developed to determine the flow blockage and total pressure losses, and measures of effectiveness and capability were created for data analysis.

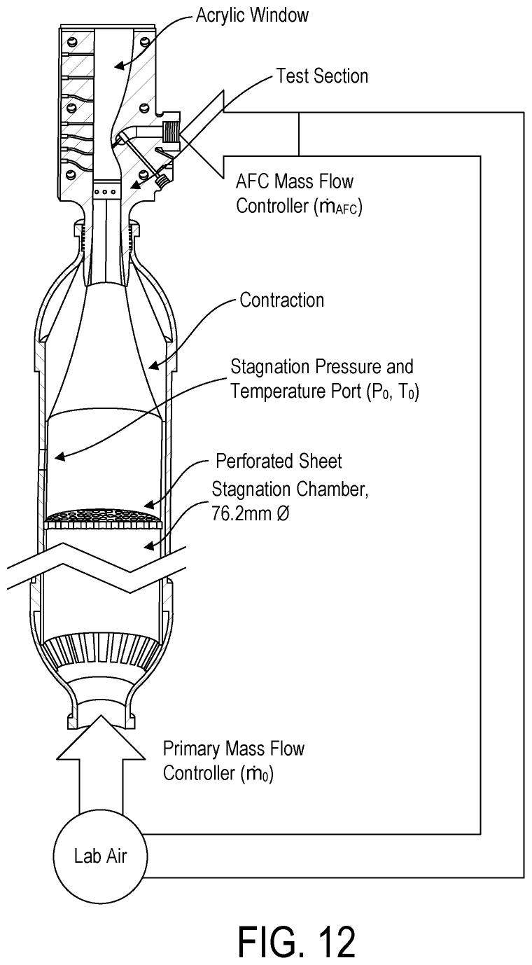

FIG. 12 shows a schematic of the rig design along with a converging-diverging nozzle test section. High-pressure compressed air is sourced from the lab and is regulated with a set of pressure regulators and Alicat mass flow controllers with an accuracy of ±1%. The primary flow is capable of reaching 3000 standard liters per minute (SLPM) and the injection flows 1000 SLPM or 100 SLPM depending on the requirements for a given actuator pressure ratio. Flow to multiple actuators can be controlled independently. The primary flow passes into a stagnation chamber and through a set of perforated plates. Static pressure and temperature taps are located prior to the contraction and stagnation chamber exit. Threads at the exit of the stagnation chamber and a mating joint on the contraction allow for a test section to be mounted with minimal disturbances to the flow.

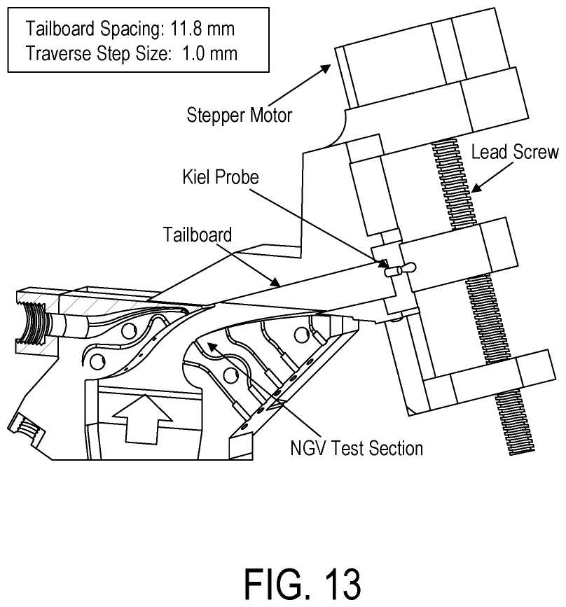

The test section is constructed using stereolithography additive manufacturing and is sandwiched between two acrylic plates, which allows for a shadowgraph setup to visualize the internal flow. A point light source flashlight and parabolic mirror project a cylinder of columnated light, which passes through the test section. A DSLR camera was used to capture the resulting shadows due to density gradients within the flow. Finally, a total pressure Kiel probe was mounted at the test section exit on a traverse to measure the total pressure profile and loss. For the NGV test sections, a tailboard was added with the average turning angle, and the total pressure traverse was mounted normal to the exiting flow, as shown in FIG. 13. The test sections also contain a series of static pressure taps. All pressures were measured with a 9116 Intelligent Pressure Scanners from NetScanner™ at a rate of 1000 Hz with an accuracy of ±0.05%. Temperature measurements were obtained with a K-Type thermocouple and an NI9211 DAQ. These were controlled, together with the mass flow controllers, with a custom LABVIEW program, which was used to set test conditions and record mass flow, pressure, and temperature data.

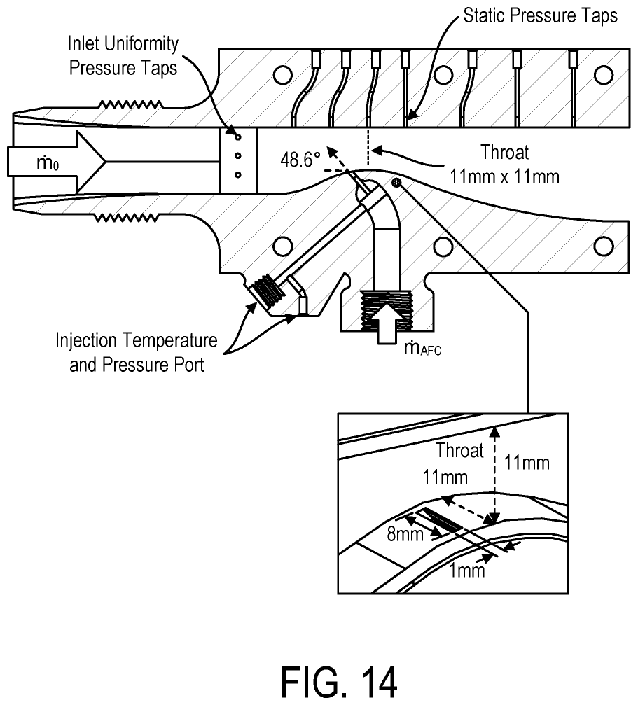

Three different test sections were used. The first was a 2D converging-diverging Nozzle (CDN) with an 11 mm by 11 mm throat, as shown in FIG. 14. Upstream of the contraction was a set of six static pressure taps to measure inlet flow uniformity. Along the straight wall were a series of seven static pressure taps at the midspan of the test section. Finally, there was an 8.0 mm by 1.0 mm cross-sectional injection slot 5.0 mm upstream of the throat and angled against the primary flow by 48.6 deg from the axial direction. Injection flow pressure and temperature were measured and used to calculate the total pressure. No specific expansion ratio was sought as the primary area of interest was at and upstream of the throat.

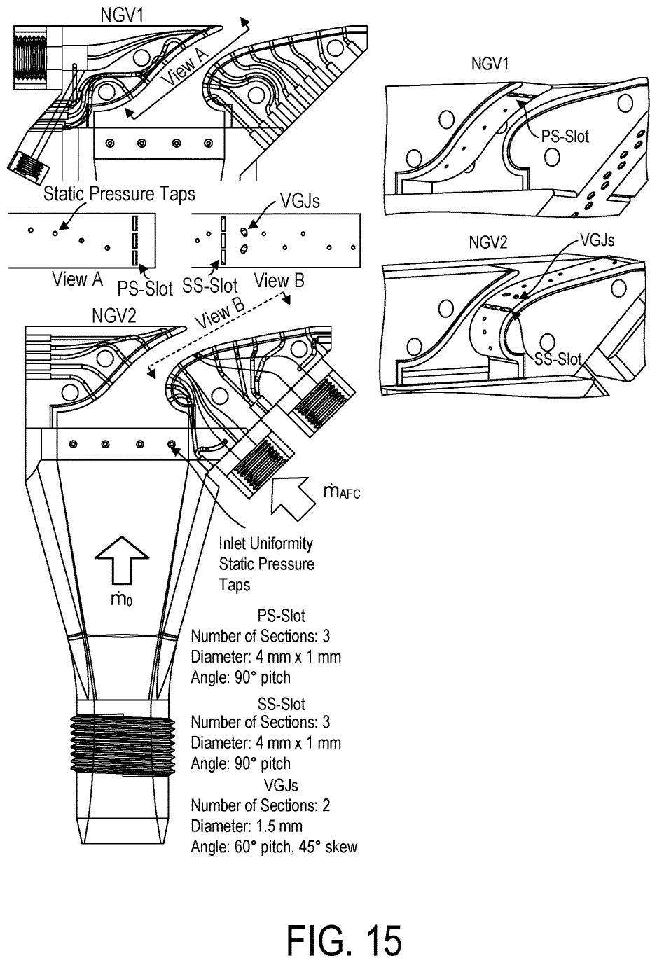

Both other designs consisted of a single nozzle guide vane (NGV) passage, which is used in an NGV profile shown in FIG. 8. The first NGV design (NGV1) had a pressure side injection AFC actuator (PS-Slot) oriented normal to the surface composed of three 4.0 mm by 1.0 mm slots located just upstream of the throat, as shown in FIG. 15. The second NGV design (NGV2), also shown in FIG. 15, had two AFC actuators located on the suction surface: a three-segment injection slot similar to NGV1 (SS-Slot) and a pair of VGJs that were located downstream at the throat. The VGJs were oriented 45 deg in the spanwise direction and 30 deg from the local surface normal.

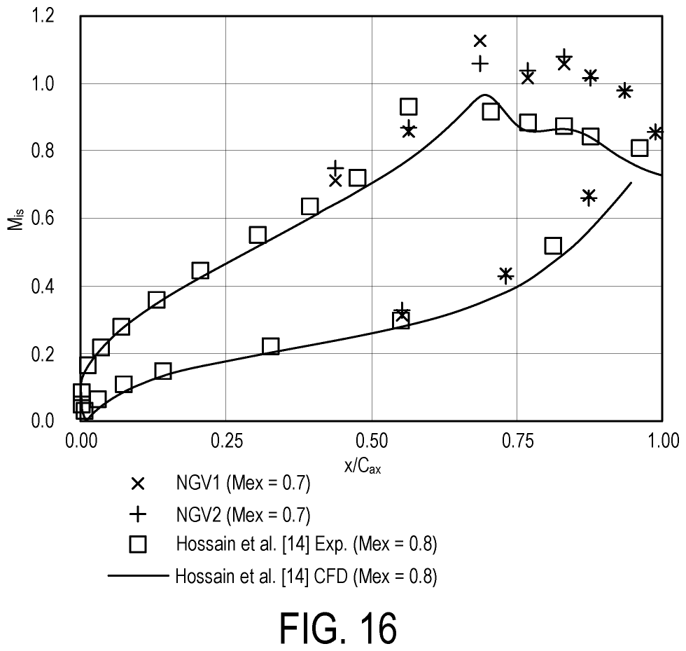

Both vanes were scaled to have a similar throat area as the converging-diverging nozzle (CDN) with a pitch of 40.9 mm and a span of 15.6 mm. The axial chord measured 26.7 mm with an additional 13.1 mm for the tailboard. Both configurations had identical pressure tap locations with four inlet pressure taps to assess the uniformity of the flow, which was estimated to have a Mach number distribution within 3% of the mean flow. A tailboard, set to the mean turning angle of the vanes (73.2 deg), was added to the exit and extended the flow path by 0.5 axial chord lengths (Cₐₓ). Pressure taps were located along both the pressure and suction surfaces of the NGV and the Mach number profile was found to be in good agreement with previous NGV computational and experimental analyses for a similar throat Mach number, as shown in FIG. 16.

To determine the effectiveness of fluidic throttling, first, the stagnation pressure ratio was selected based on the desired test point. Injected flow was added at set mass flow rates or AFC pressure ratios (PR_{AFC}=P_{T, AFC}/P_{T,0}), and the primary mass flow was decreased until the original, non-injection stagnation pressure was again reached. Ten seconds of data were recorded at each test condition. Various primary and injection flow rates were explored. Throttling mass flow effectiveness (ηₘ) was calculated as the ratio of blocked flow to injection flow (\dot{m}AFC) at the same nozzle pressure ratio (NPR), as shown in Equation (1) below.

$${η}_{m} = \frac{{\dot{m}}_{blocked}}{{\dot{m}}_{AFC}} = \frac{{{\dot{m}}_{0} ( NPR ) {\vert}_{base} - {\dot{m}}_{0} ( NPR ) \vert}_{AFC}}{{\dot{m}}_{AFC}} \qquad ( 1 )$$

For the NGV configurations, a traverse with a total pressure Kiel head was attached at the tailboard exit to measure the total pressure profile and estimate total pressure loss. The pressure was surveyed at 1.0 mm spacings (approximately 8% y/P at the exhaust) for 10 s at each location. Total pressure recovery (γₚ) is calculated as the ratio between the measured Kiel probe total gage pressure and the upstream primary flow total gage pressure. Total pressure recovery is estimated using an area average (γₐ) over the tailboard exit [Equation (2)]. Area averaging is expected to underestimate the actual work available to be extracted from the flow due to an overweighting of total pressure loss in regions of low momentum. However, given the relatively small variation in pressure recovery over the pitch, an area average is suitable for gaining an understanding of the pressure losses experienced or recovered by the use of AFC. To evaluate the changes in pressure recovery, the difference in the area averaged total pressure recovery was calculated relative to the NGV baseline [Equation (3)].

$${γ}_{a} = \frac{\int {γ}_{p} dA}{\int dA} = \frac{\int \frac{{P}_{Kiel} - {P}_{amb}}{{P}_{T} - {P}_{amb}} dA}{\int dA} \qquad ( 2 )$$

$${{Δγ}_{a} = {γ}_{a} {\vert}_{AFC} - {γ}_{a} \vert}_{base} \qquad ( 3 )$$

Finally, blocked flow fraction (BFF) was used as a measure of the capabilities of an AFC system [Equation (4)]. While throttling effectiveness represents the efficiency with which an actuator can throttle the primary flow, blocked flow fraction measures the amount of primary flow, which can be ultimately blocked. This is an important parameter as the flow supply for a VAT AFC system is expected to come from the final stages of the compressor. After accounting for a small drop in pressure across the combustor, the AFC pressure ratio (PR_{AFC}) is expected to be only slightly greater than one, which limits the amount of AFC flow, and in return the amount of blocked flow, for an AFC system.

$$BFF = \frac{{\dot{m}}_{blocked}}{{\dot{m}}_{0 , base}} \qquad ( 4 )$$

### Results and Discussion

Injected Mass Flow Throttling Effectiveness—The effectiveness and losses of various AFC techniques are multifaceted. First, the effectiveness of throttling the primary flow in terms of injected AFC mass flow is explored for both the CDN and NGV designs. Next, the effect of the primary flow Mach number is examined. Finally, the results of the NGV total pressure surveys at the flow exit are explored, and the capabilities of the actuators are presented in terms of total blockage.

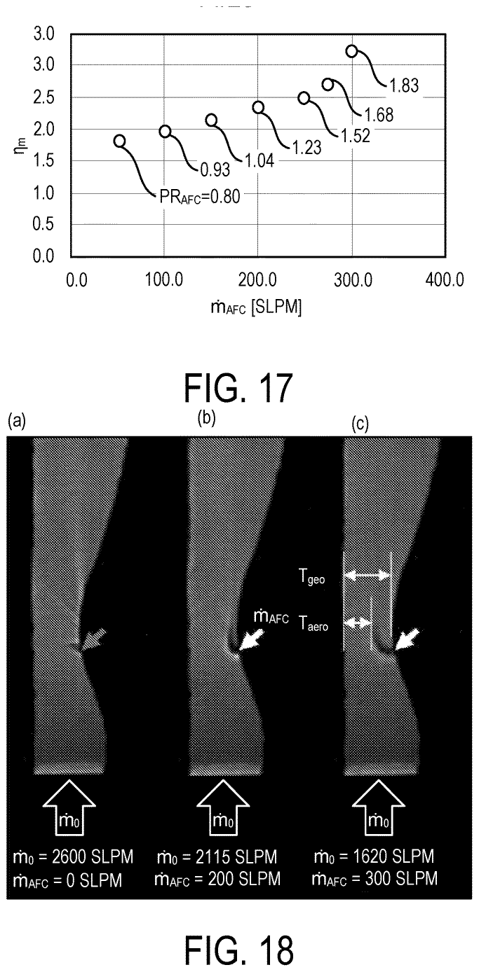

First, the mass flow throttling effectiveness was explored with the CDN. The nozzle pressure ratio was set to a constant 1.73, which resulted in an isentropic throat Mach number of 0.95 and a primary mass flow rate of 2600 SLPM. The Throat Mach number was estimated using isentropic flow relations and the ratio between upstream stagnation pressure and local static pressure. Various amounts of AFC flow between 50 SLPM and 300 SLPM were injected through the upstream slot, and the resulting mass flow throttling effectiveness (ηₘ) was recorded, as shown in FIG. 17. Values of throttling effectiveness greater than unity indicate that more primary flow is blocked relative to the amount of injected air. At 100 SLPM of injected AFC flow, the effectiveness was approximately 2.0, indicating that relative to the equivalent NPR, 200 SLPM of primary flow was blocked (only 2400 SLPM was passed). As the amount of injected flow increased, the resulting effectiveness also increased, up to 3.2 at 300 SLPM. The corresponding AFC pressure ratio values are also noted for each data point in FIG. 17 to provide a sense of the system-level requirements (P_{T, AFC}) needed to obtain the desired ηₘ.

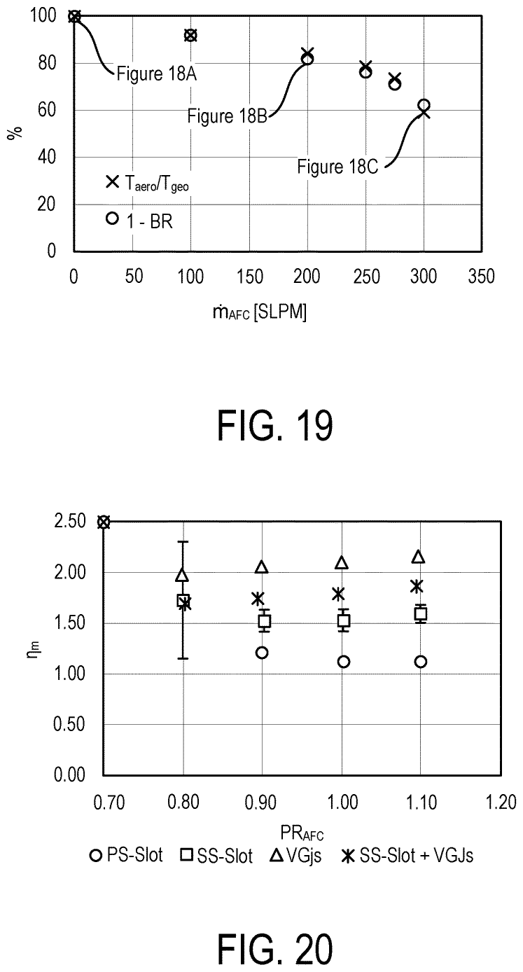

An effectiveness greater than one also indicates that the injected flow does more than simply displace the equivalent amount of primary flow. Shadowgraph images of baseline, 200 SLPM, and 300 SLPM of injected flow are presented in FIG. 18. Primary flow moves from bottom to top, and the injected flow location and angle are indicated by the arrow on the right side of the flow path. The boundary between the injected and primary flow is visible, and the AFC flow penetration increases with the increasing mass flow. The resulting aerodynamic throat, estimated from the shadowgraph images, is presented in FIG. 19 and roughly matches the reduction in primary flow. This trend held for the other injected flow cases (shadowgraph images not displayed). Injecting flow alters the aerodynamic throat, which in turn restricts the amount of primary flow for a given NPR.

The throttling effectiveness was also examined for the various AFC actuators implemented on the NGV designs, as shown in FIG. 20. The NPR was kept constant at 1.52, which corresponds to an isentropic exit Mach number of 0.8, and various AFC pressure ratios (PR_{AFC}) were studied. The PS-Slot was only examined at three pressure ratios as there was a larger initial static pressure at that location relative to the suction side locations. Each test point was repeated three times, and the typical precision error is displayed for the SS-Slot case only. An increase in the AFC pressure ratio corresponded to an increase in injected mass flow. In general, the actuators on the suction side increased in effectiveness with increasing PR_{AFC}. It is unclear whether this trend holds for the SS-Slot at low PR_{AFC} due to the large uncertainty exhibited at low injection flow rates. In contrast, increasing the PR_{AFC} for the PS-Slot resulted in a slight decrease in throttling effectiveness. However, each of these changes was relatively small over the AFC pressure ratios tested. Of more interesting note are the differences in effectiveness between actuators or combinations of actuators. The most effective actuators were the VGJs, which had an average effectiveness of 2.1. This was followed by the SS-Slot with an average effectiveness of 1.6 and the PS-Slot with the lowest effectiveness of 1.2. Injecting flow from both the SS-Slot and VGJs resulted in an average effectiveness between that of the individual actuators at 1.8. Of note, each of these actuators has effectiveness above one, and further optimizations of the location and angle of the injected flow could improve these results.

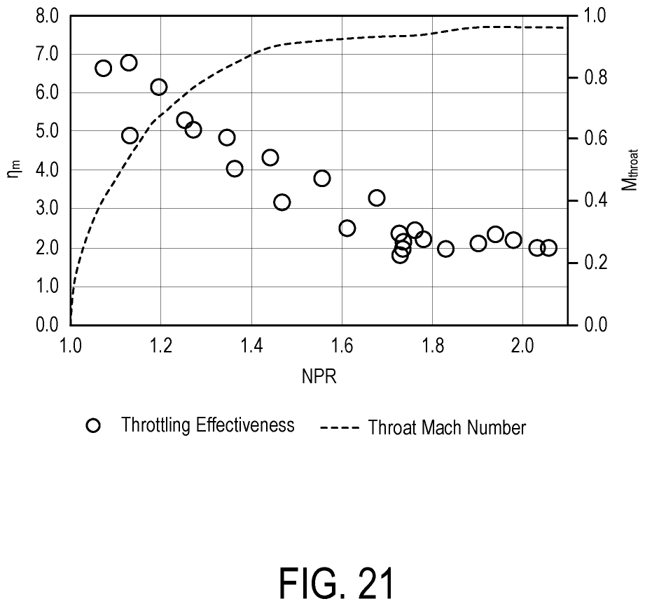

Primary Flow Mach Number—Next, the effect of primary flow Mach number on the throttling effectiveness was investigated. FIG. 21 plots the effectiveness of the CDN slot injection over a variety of NPRs. The injection flow rates were between 50 SLPM and 200 SLPM. Additionally, the isentropic throat Mach number for the baseline flow at each NPR is also included on the secondary axis. As the nozzle pressure ratio increases, the throttling effectiveness decreases up to an NPR of 1.8. Beyond 1.8, increases in NPR no longer produce an increase in Mₜₕᵣₒₐₜ, and the AFC effectiveness levels out at approximately 2.2.

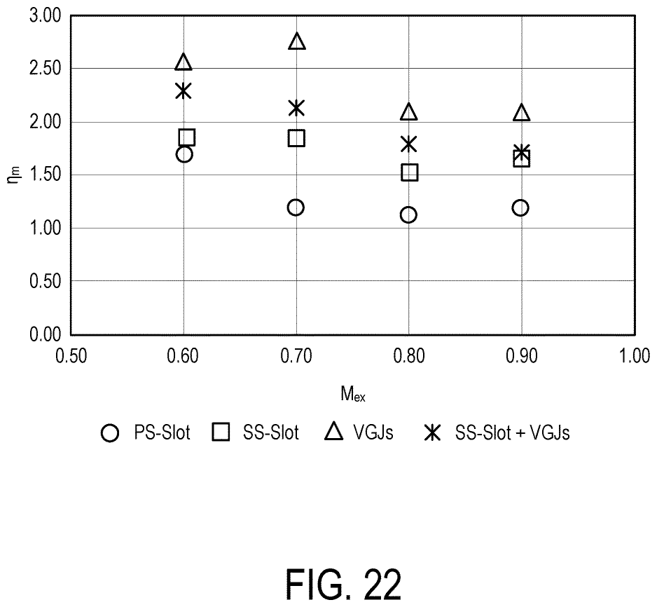

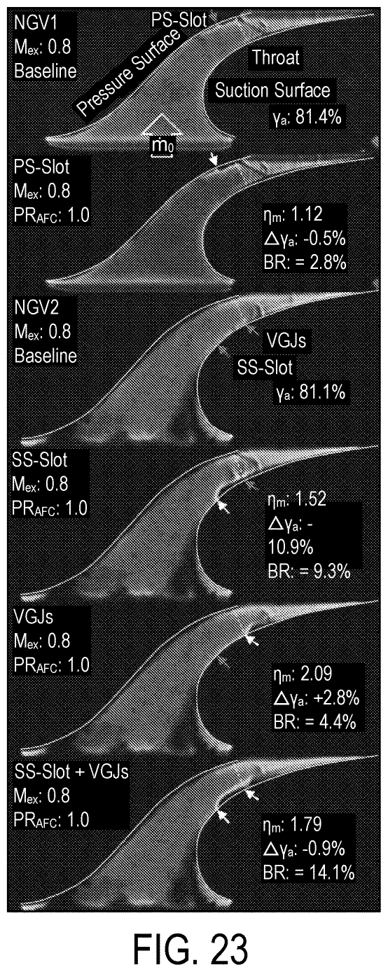

FIG. 22 plots the effectiveness of each of the NGV AFC configurations at a PR_{AFC} of 1.0 over a range of exit Mach numbers, estimated using the NPR. The general trend of decreasing throttling effectiveness with increasing primary flow Mach Number was also noted for each of the AFC configurations. The order of effectiveness between each AFC method was maintained over the range of exit Mach numbers examined. Also of note is an apparent shift in effectiveness between exit Mach numbers of 0.7 and 0.8. This corresponds with the appearance of shocks in the baseline flow near the throat, as observed by the shadowgraph images shown in FIG. 23.

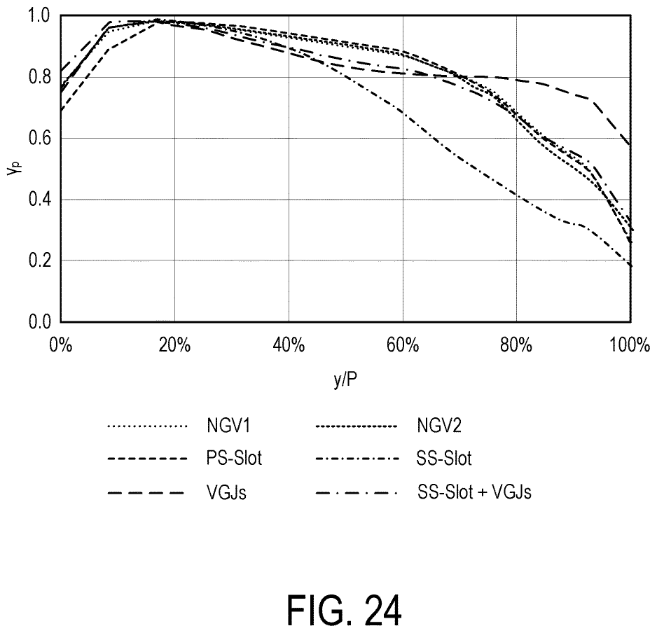

Total Pressure Recovery—In addition to throttling effectiveness, other important effects of an AFC method were investigated for the NGV configurations, including changes in the exit angle and the total pressure recovery. FIG. 24 plots the various pressure recovery profiles at Mₑₓ=0.8 and PR_{AFC}=1.0. Both the NGV1 and NGV2 configurations serve as baseline profiles (without injected flow) and have matching total pressure profiles. At the pressure surface (0% y/P), each of the actuators has a similar pressure profile as the baseline with the exception of the PS-Slot design. In addition to having a slightly lower pressure recovery near the pressure surface, in part due to the larger wake created by blocked flow, the peak in the pressure recovery for the PS-Slot design was also slightly shifted toward the suction surface, from 17% y/P to 25% y/P. This small shift of approximately 8% could represent a change in the exit angle of the flow, which if traced from the survey plane back to the trailing edge plane of the NGVs would represent a 1.1 deg shift in the exit angle. The suction surface AFC methods resulted in a decrease in total pressure mid-pitch (30%<y/P<50%). Beyond 50% y/P, a significant decrease in total pressure was observed for the SS-Slot configuration, likely due to an increased wake because of the blockage created by the injected flow. In contrast, the total pressure for the VGJ design intersects the baseline profile at approximately 70% y/P and produces a greater pressure recovery near the suction surface. A combination of the SS-Slot and VGJ configurations intersects and matches the baseline total pressure profile between 70% and 100% y/P. By using separation reduction techniques such as vortex-generating jets, the large wake was reduced, and a greater total pressure recovery was achieved.

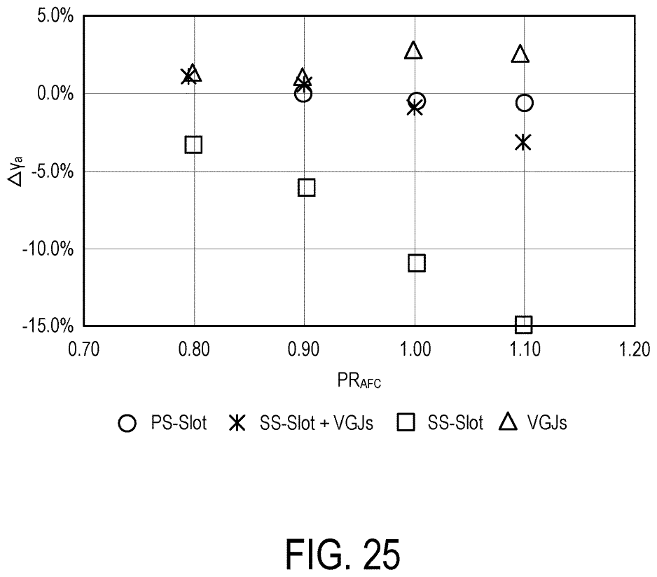

The area average total pressure recovery (γₐ) was calculated for each of the AFC actuators at Mₑₓ=0.8, as shown in FIG. 25. The baseline configuration produced an average pressure recovery of 0.81. As expected from the pressure profile, the SS-Slot configuration produced the smallest pressure recovery of the configurations tested, which decreased with increasing AFC injection. In contrast, the PS-Slot actuator matched the baseline pressure recovery over the PR_{AFC} examined. At larger injection flows, the VGJs increased the total pressure recovery by up to 3 percentage points over the baseline and had an increase in pressure recovery with increasing PR_{AFC}. When used in conjunction with the SS-Slot injection flows, the VGJs were able to reduce the large losses in total pressure, boosting the total pressure recovery to just 0.9% below baseline at a PR_{AFC} of unity. One explanation for this pressure recovery is that the VGJs create vortices within the flow, which act to bring in higher momentum flow from the freestream into the wake created by the upstream SS-Slot. This higher momentum flow energizes the suction surface boundary layer flow, increasing total pressure recovery.

Shadowgraph images of each of the AFC actuators are presented in FIG. 23. The NGV1 and NGV2 images represent the baseline flows at an exit Mach number of 0.8. The oblique shock in the NGV1 design is likely due to the presence of the PS-Slot despite no flow being injected. The PS-Slot was left uncovered when blowing was not employed. Injecting flow from the PS-Slot did not have a large visual effect on the flow with the exception of a small region of injected flow visible near the pressure surface. In contrast, injecting flow from the SS-Slot produced a large region of injected flow, noticeably decreasing the aerodynamic throat, and remaining near the suction surface for an extended distance downstream. The VGJs produced a visually similar region of injected flow although the downstream propagation quickly diffused, in part due to the reduced flow injected and increased mixing by the streamwise vortices generated. Finally, a combination of the SS-Slot and VGJs showed two distinct injection locations, which indicated that the VGJs were able to penetrate into the freestream flow. Similar to the individual VGJs, downstream of the combined VGJs and SS-Slot, the flow quickly mixes out.

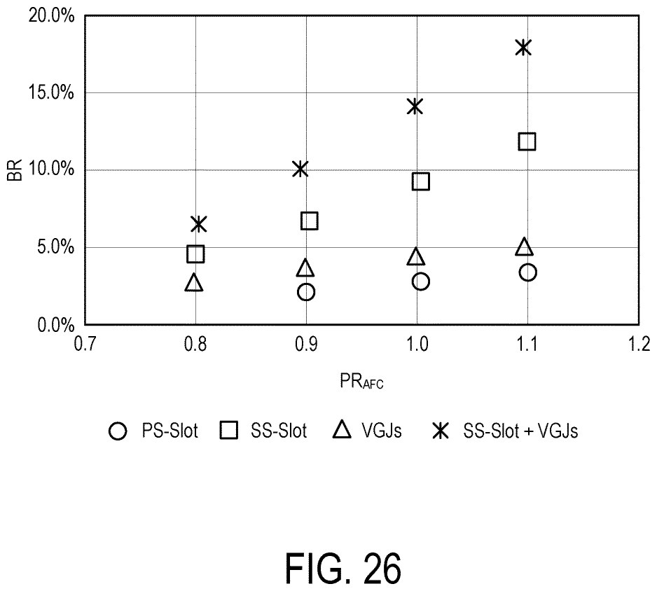

Absolute Blockage—While throttling effectiveness and total pressure recovery are measures of the efficiency of the AFC systems, total blockage is a measurement of their capabilities. Because of varying injector sizes and local static pressures, the injected mass flowrate varies between actuators for a given AFC pressure ratio. Further optimizations to the embedded actuator designs may improve their discharge ratios. The injected flow, in combination with the throttling effectiveness [Eq. (1)], represents the absolute blocked flow [Eq. (4)]. FIG. 26 plots the variation in blocked flow for each of the actuators over the tested PR_{AFC} range (0.8-1.1). The PS-Slot configuration has the lowest blocked flow due to its high local static pressure combined with its limited effectiveness. VGJs produced the next largest total blockage with a maximum blocked flow fraction of 5.1%. Despite having the largest throttling effectiveness, the small injection area resulted in a limited amount of mass flow relative to the SS-Slot design. The SS-Slot produced a maximum blockage of 11.8% due to its ability to inject more flow for a given pressure ratio than the VGJs. Combined, the SS-Slot and VGJs produced the largest blockage of 17.9%, which is greater than the sum of both the SS-Slot and VGJ blockages. It was noted that ejecting blocking flow from the SS-Slot reduced the static pressure at the VGJs, which in turn would drive more flow through the highly effective actuator than if it was operating independently.

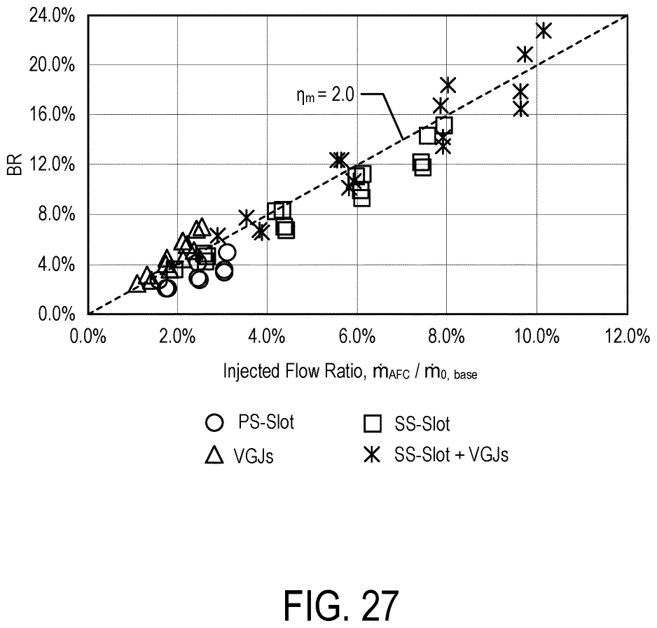

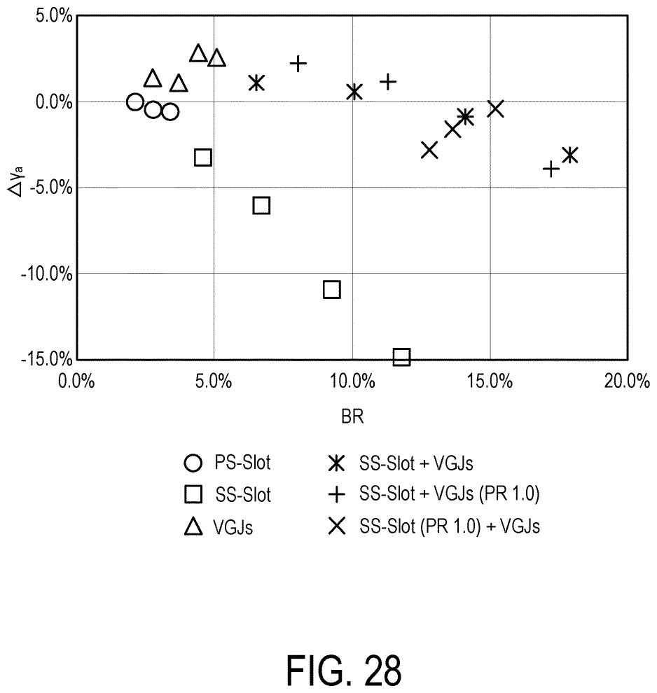

A summary of the injected flow and blocked flow is plotted in FIG. 27. All data were gathered between exit Mach numbers of 0.6 and 0.9 with a PRAFC between 0.8 and 1.1. The dotted line represents a mass flow throttling effectiveness of two. Points above the dotted line represent actuators with increased effectiveness, such as the VGJs. The PS-Slot configuration data points are in contrast less effective on a mass flow basis. Both the VGJs and PS-Slot have limited maximum effectiveness in comparison with the SS-Slot and combination of SS-Slot and VGJs, which can reach a maximum blockage of 22.7% (Mₑₓ=0.6, PR_{AFC}=1.1). For a single exit Mach number (0.8), FIG. 28 plots the change in total pressure recovery as a function of the blocked flow. Within an actuator group, increases in blocked flow correspond with increases in pressure ratio and injected mass flow. In addition to the previous actuator designs, two new combinations of AFC injection are included. These represent a combination of the SS-Slot and VGJs where one of the two actuators is held at a constant PR_{AFC} of unity, while the other actuator's PR_{AFC} is varied. This allows for a visualization of the effect of independently varying each actuator on the blockage and pressure recovery. When the VGJs are held at a constant pressure ratio of one (+), altering the SS-Slot injection has a larger effect on the total blockage relative to the pressure recovery. However, when the SS-Slot is held at a constant pressure ratio (+), the VGJ injection has a greater influence on the total pressure recovery. This indicates that the majority of the blockage is being performed by the SS-Slot, while the pressure recovery is more strongly influenced by the VGJs.

Conclusion—A small-scale flow throttling rig was constructed and used to investigate various methods of AFC for both a convergent divergent nozzle and a single-nozzle guide vane flow path. Various AFC actuators, locations, and combinations of actuators were examined. Reduction in the primary mass flowrate for a given nozzle pressure ratio was measured, along with the injection pressure ratio, actuator mass flow, and total pressure along the nozzle exit midspan. Calculations of mass flow throttling effectiveness and total pressure recovery were used as indicators of actuator efficiency. The following actuator performances were observed:
Each of the AFC actuators was able to successfully throttle the primary flow beyond simple displacement by altering the aerodynamic throat.
Increasing the primary flow Mach number generally reduces the mass flow throttling effectiveness.
PS-Slot injection produced exit pressure profiles, which indicated a 1.1 deg increase in the exit angle.
The SS-Slot configuration resulted in large wakes, which reduced the total pressure recovery.
VGJs were successfully used to reduce the wake size and total pressure loss following the SS-Slot injection.
A combination of SS-Slot and VGJs actuators produced the greatest reductions in primary flow, up to 22.7%, at PR_{AFC}=1.1 and Mₑₓ=0.6.

### Configuration of Certain Implementations

The construction and arrangement of the systems and methods as shown in the various implementations are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

1. A system comprising:
a first blade and a second blade, each of the first blade and the second blade comprising an upper surface, a lower surface spaced apart from the upper surface, a leading edge, and a trailing edge, wherein the first blade and the second blade are spaced apart to define a throat area through which a fluid can flow in a direction from the leading edge to the trailing edge;
a first active flow control port disposed on the upper surface of the first blade; and
a second active flow control port disposed on the upper surface of the first blade closer to the trailing edge than the first active flow control port,
wherein each of the first and second active flow control ports is configured to inject a control fluid into the throat area to vary at least one of (i) a cross-sectional area of the fluid flowing through the throat area and (ii) an exit angle of the fluid as it leaves the throat area adjacent to the trailing edge.

2. The system of claim 1, wherein the first active flow control port is a blockage port configured to inject the control fluid into the throat area to reduce the cross-sectional area of the fluid flowing through the throat area.

3. The system of claim 1, wherein the second active control port is a recovery port placed in close proximity to the blockage port, the recovery port being closer to the trailing edge of the first blade than the blockage port, wherein each of the blockage port and the recovery port is configured to inject the control fluid into the throat area to vary the cross-sectional area of the fluid flowing through the throat area.

4. The system of claim 1, wherein the control fluid from the blockage port separates the fluid from the first blade.

5. The system of claim 1, wherein the control fluid from the recovery port attaches the fluid back to the first blade.

6. The system of claim 1, wherein the upper surface of the first blade is a suction surface of the first blade, the lower surface of the second blade is a pressure surface, and the throat area is defined by the pressure surface of the second blade and the suction surface of the first blade.

7. The system of claim 1, wherein the system is a turbine system and the first blade and the second blade are turbine blades.

8. The system of claim 1, wherein the second active flow control port is a vortex-generating jet.

9. The system of claim 1, wherein the control fluid exiting the second active flow control port oscillates with a first frequency in a plane substantially parallel to the upper surface of the first blade.

10. The system of claim 1, further comprising a third active flow control port disposed on the lower surface of the second blade opposite of the first and second active flow control ports.

11. The system of claim 1, wherein the exit angle of the fluid as it leaves the throat area is altered by greater than 1 degree when the control fluid is dispensed from the third active flow control port.

12. The system of claim 1, further comprising a control fluid source in fluid communication with the first and second active flow control ports.

13. The system of claim 1, wherein the first active flow control port is a plurality of first active flow control ports arranged on the upper surface of the first blade in a transverse direction along the width of the first blade that is perpendicular to the direction of the fluid flowing through the throat area.

14. The system of claim 1, wherein the second active flow control port is a plurality of second active flow control ports arranged on the upper surface of the first blade in the transverse direction.

15. The system of claim 1, wherein the second active flow control port is placed on the upper surface of the first blade directly opposite the trailing edge of the second blade.

16. The system of claim 1, wherein a blocked flow fraction of the first and second active flow control ports is greater than 10%.

17. A system comprising:
a plurality of turbine blades arranged adjacent to each other in a device, the plurality of turbine blades including a first blade and a second blade each comprising an upper surface, a lower surface spaced apart from the upper surface, a leading edge, and a trailing edge, wherein the first blade and the second blade are spaced apart to define a throat area through which a fluid can flow in a direction from the leading edge to the trailing edge;
a first active flow control port disposed on the upper surface of the first blade;
a first injector plenum partially defined by the first blade and in fluid communication with the first active flow control port;
a second active flow control port disposed on the upper surface of the first blade closer to the trailing edge than the first active flow control port; and
a second injector plenum partially defined by the first blade and in fluid communication with the second active flow control port, the second injector plenum being separate from the first injector plenum,
wherein each of the first and second active flow control ports is configured to inject a control fluid into the throat area to vary at least one of (i) a cross-sectional area of the fluid flowing through the throat area (e.g., vary the nozzle guide vane throat area) and (ii) an exit angle of the fluid as it leaves the throat area adjacent to the trailing edge.

18. The system of claim 17, wherein the first active flow control port is a plurality of first active flow control ports arranged on the upper surface of the first blade in a transverse direction along a width of the first blade that is perpendicular to the direction of the fluid flowing through the throat area.

19. The system of claim 17, further comprising a fluid source in fluid communication with one or more of the first injector plenum and the second injector plenum.

20. A method of altering the flow conditions through a turbine system, the method comprising:
providing turbine comprising:
at least one turbine blade including a first blade and a second blade, each of the at least one turbine blades having an upper surface, a lower surface spaced apart from the lower surface, a leading edge, and a trailing edge, wherein the first blade and the second blade are spaced apart to define a throat area through which a fluid can flow in a direction from the leading edge to the trailing edge;
a first active flow control port disposed on the upper surface of the first blade; and
a second active flow control port disposed on the upper surface of the first blade closer to the trailing edge than the first active flow control port,
injecting a control fluid into the throat area via the first active flow control port to disconnect the fluid flowing through the throat area from the upper surface of the first blade, thus reducing an effective throat area; and
injecting a control fluid into the throat area via the second active flow control port to reattach the fluid flowing through the throat area to the upper surface of the first blade, wherein the control fluid injected via the second active flow control port oscillates with a first frequency in a direction transverse to the fluid flow direction,
wherein the reduced flow conditions in the throat area produce an increased efficiency of the turbine system.
